(19) United States
(12) Patent Application Publication
(10) Pub. No.: US 2014/0236457 A1
(43) Pub. Date: Aug. 21, 2014

(54) ENGINE PROVIDING A SELF-ADJUSTING SYSTEM AND A METHOD TO SAVE FUEL IN ACCORDANCE WITH A PRACTICAL DRIVING STATE OF A VEHICLE

(71) Applicant: XIAMEN KING LONG UNITED AUTOMOTIVE INDUSTRY CO., LTD., (US)

(72) Inventors: Xiaobing CHEN, Xiamen City (CN); Yifan XU, Xiamen City (CN); Fangming ZHOU, Xiamen City (CN); Weihong YE, Xiamen City (CN); Wei LI, Xiamen City (CN); Guoqiang CHEN, Xiamen City (CN); Lei HUANG, Xiamen City (CN)

(21) Appl. No.: 13/772,213

(22) Filed: Feb. 20, 2013

(51) Int. Cl. F02D 45/00

(52) U.S. Cl. CPC F02D 45/00
USPC 701/110

(57) ABSTRACT

An engine provides a self-adjusting system and a method to save fuel in accordance with a practical driving state of a vehicle. The engine self-adjusting system includes an information center and a plurality of onboard computers. Each onboard computers has a vehicle controlling module for adjusting a response features of the engine so as to reduce influences of improper driving manners. An optimized standard road resistance characteristic coefficient is applied as a more valuable reference, so that the fuel consumption is efficiently reduced while keeping the vehicle powerful.

### FIELD OF THE INVENTION

The present invention is to control a vehicle engine, especially related to an engine providing a self-adjusting system and a method to save fuel in accordance with a practical driving state of a vehicle. By controlling the engine, a vehicle fuel consumption of the vehicle is efficiently decreased while the vehicle keeps being powerful.

### DESCRIPTION OF THE RELATED ART

According to a dynamic response property of an engine, when a pedal keeps a steady changes smoothly, a dynamic relationship between an engine torque and an engine rotation speed tends to be linear. When the accelerator pedal has a step change, an experiment shows that when the accelerator pedal provides a 100% step change, the fuel consumption increases, and the exhaust becomes deterioration.

While starting, accelerating, and shifting gears, drivers often step the accelerator pedal heavily in order to speed up the vehicle in a short time. When the vehicle runs in an expected speed, drivers slack the accelerator pedal. Such driving manner is adverse to the engine since a lot of fuel is not completely consumed. As a result, the fuel consumption increases. Moreover, since the engine torque increases transiently, the over accelerated speed results in overshoot, which needs a brake to decelerate. Obviously, the energy is wasted. An economical driving is that the accelerator pedal should be gently stepped, and the frequent acceleration or deceleration should be prevented.

Hence, the present invention is to optimize the high fuel consumption in view of the improper driving manners.

### SUMMARY OF THE INVENTION

The first object of the present invention is to provide an engine providing a self-adjusting system in accordance with a practical driving state of a vehicle so as to decrease the fuel consumption while the vehicle keeps being powerful.

Afore object is achieved by following means:

An engine providing a self-adjusting system in accordance with a practical driving state of a vehicle comprises an information center and a plurality of onboard computers connected to the information center;

each onboard computer includes:

a GPS module for acquiring information of a current location of the vehicle and sending the information to the information center;

a driving data collecting module for collecting running parameters of the vehicle; the driving data of the vehicle includes vehicle speed, engine speed, engine torque, position of the accelerator pedal, and position of the breaking pedal;

a vehicle parameter and engine data module for storing a vehicle configuring and engine operating parameter according to different power requirements;

a computing module for computing a current driving parameter according to the driving data from the driving data collecting module; the current driving parameter includes acceleration of the vehicle, a change rate of the accelerator pedal, and gear of the vehicle; the computing module cooperates with the vehicle configuring from the vehicle parameter and engine data module so as to figure out the current road resistance characteristic coefficient;

a decision module acquires a standard road resistance characteristic coefficient from a route-optimized module, current road information from a map data module, and the current driving parameter from the computing module so as to judge the power requirement of the vehicle; a correspondent engine operating parameter is acquired from the vehicle parameter and engine data module in accordance with the power requirement of the vehicle;

a vehicle controlling module for receiving the engine operating parameter and controlling the output features of the engine;

the information center includes:

a map data module for storing map information and calling the road information in accordance with the information of the current location of the vehicle from the GPS module;

a history data module connected with the onboard computers for storing the current road resistance characteristic coefficient computed by the computing module when each onboard computer passes the area recently; the history data module analyzes and compares the current road resistance characteristic coefficients from different onboard computers; and

a route-optimized module connected with the history data module for calling the standard road resistance characteristic coefficient corresponding to the current road information; the route-optimized module further sends the standard road resistance characteristic coefficient corresponding the current location to the decision module of the onboard computers.

Preferably, each onboard computer includes a human-machine interface module for drivers to input route information; the route information includes a vehicle load and a route information; the decision module judges the power requirement of the vehicle according to the driving parameter, the current road information, the standard road resistance characteristic coefficient, and the driving parameter.

Preferably, the vehicle configuring includes ratio of gearbox, ratio of final drive, maximum total mass of the vehicle, wheel rolling radius, transmission efficiency, a coefficient of the revolving mass changes to linear mass, drag coefficient, and frontal area.

Preferably, the current route information includes a gradient, pavement condition, a road information, and dynamic traffic information.

The second object of the present invention is to provide a method to save fuel in accordance with a practical driving state of a vehicle including a step of collection and optimization, and a step of execution; wherein, the step of collection and optimization includes:

A1. presetting a vehicle configuring and an engine operating parameter corresponding to different power requirements in each onboard computer; presetting map information related to traveling areas of the vehicle in an information center; and

A2. allowing each onboard computer to collect current route information and combine with the vehicle configuring coefficient so as to compute the current driving parameter and a current road resistance characteristic coefficient; sending a combination of the current road resistance characteristic coefficient and a current location of the vehicle achieved by the information center so as to store up as history data, which further resulting in a standard road resistance characteristic coefficient corresponding to the current road;

the step of execution includes:

B1. computing the standard road resistance characteristic coefficient corresponding to the current location of the vehicle;

B2. using the current route information, the current driving parameter, and the standard road resistance characteristic coefficient so as to computing power requirement of the vehicle and the engine operating parameter of the vehicle in accordance with the requirement; and

B3. controlling an output features of the engine in accordance with the engine operating parameter.

Preferably, in step A1, a human-machine interface module is arranged for drivers to input route information; the route information includes a vehicle load and a route features; in step A2, using the vehicle load when the driving parameter is computed; in step B2, using the route information, the current road information, the standard road resistance characteristic coefficient, and the driving parameter to judge the power requirement of the vehicle.

Preferably, the vehicle configuring coefficient includes ratio of gearbox, ratio of final drive, maximum total mass of the vehicle, wheel rolling radius, transmission efficiency, a coefficient of the revolving mass changes to linear mass, drag coefficient, and frontal area.

Preferably, the route information includes vehicle speed, a engine speed, an engine torque, position of the accelerator pedal, and position of the breaking pedal; the current driving parameter includes a running resistance, an acceleration of the vehicle, a change rate of the accelerator pedal position, and a gear.

Preferably, the current route information includes a gradient, pavement condition, a road information, and dynamic traffic information.

Accordingly, the history data module records and summarizes the road resistance characteristic coefficients computed by all of the onboard computers, so that correspondent standard road resistance characteristic coefficients are acquirable after further analyzed. Subsequently, the decision module computers the power requirement of the vehicle according to the current driving parameter, the standard road resistance characteristic coefficient, and the current route information. The engine operating parameter is correspondingly acquired from the vehicle parameter and engine data module in accordance with the power requirements of the vehicle and executed by the vehicle controlling module. When the vehicle controlling module executes the adjustment of the response features of the engine, influences resulted from improper driving manners are reduced. Moreover, the standard road resistance characteristic coefficient is an optimized value acquired by combining many vehicles. Therefore, the standard road resistance characteristic coefficient is more valuable. Consequently, when the vehicle keeps being powerful, the output features of the engine is controlled more reasonably, and thereby the fuel consumption is efficiently decreased.

### BRIEF DESCRIPTION OF THE DRAWINGS

FIG. 1 is a block diagram showing an engine providing a self-adjusting system in accordance with a practical driving state of a vehicle;

FIG. 2 is a block diagram showing components in a onboard computer of the engine providing the self-adjusting system; and

FIG. 3 is a block diagram showing components in an information center of the engine providing the self-adjusting system.

### DETAILED DESCRIPTION OF THE PREFERRED EMBODIMENTS

Following embodiments give the present invention more clear explanations.

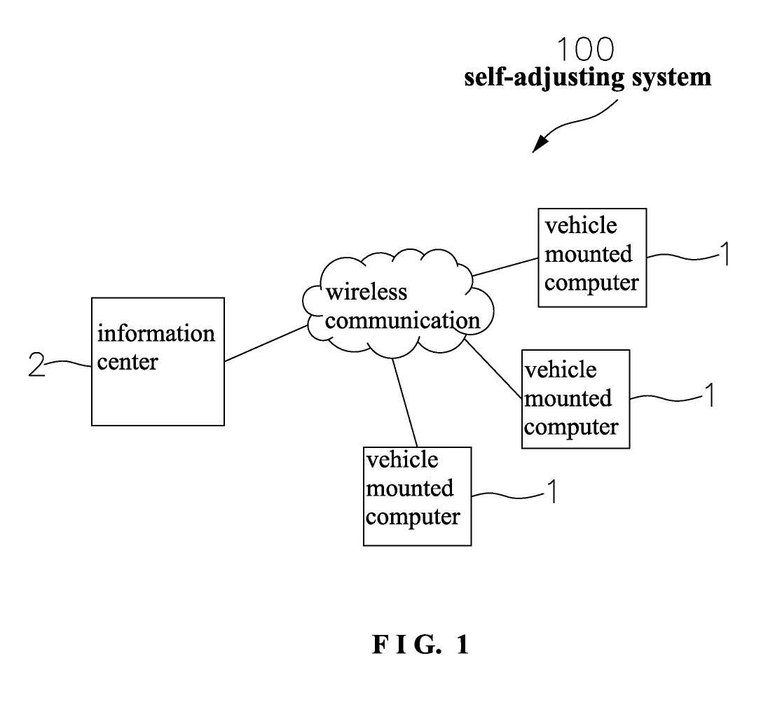

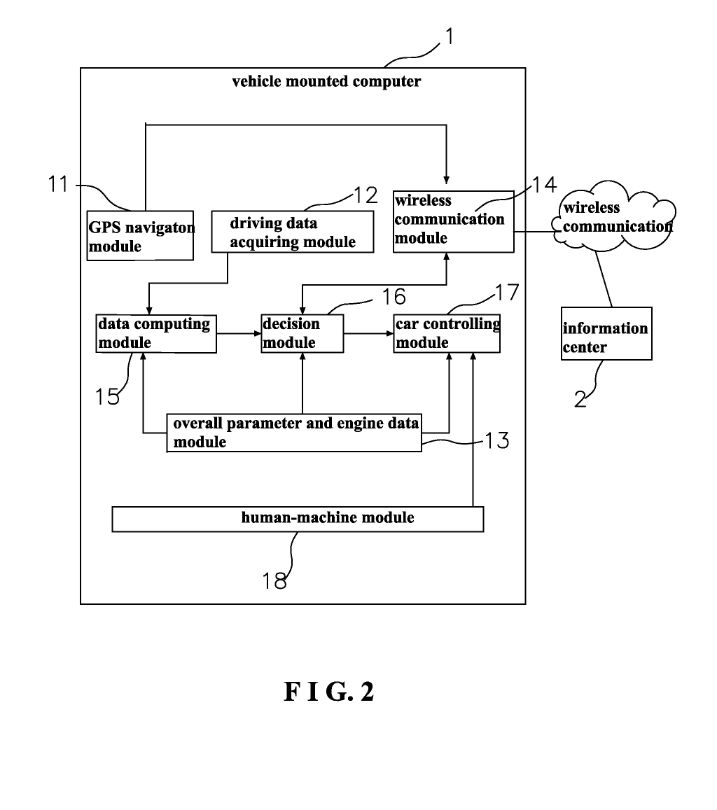

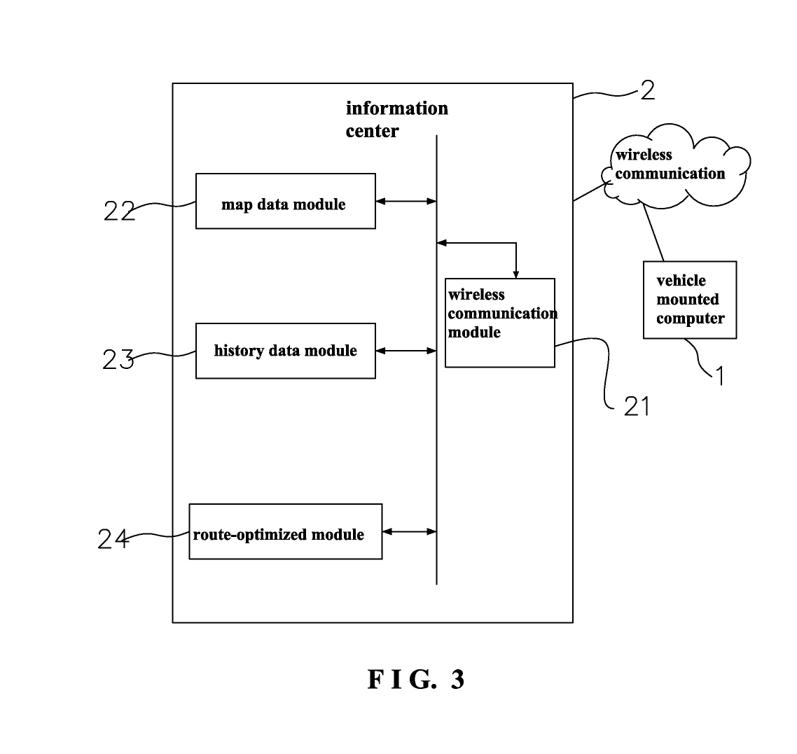

Referring to FIGS. 1 to 3, a block diagram of an engine providing a self-adjusting system 100 in accordance with a practical driving state of a vehicle is shown. The self-adjusting system 100 of the engine comprises an information center 2 and a plurality of onboard computers 1 connected to the information center 2.

Each onboard computer 1 includes a GPS module 11, a driving data collecting module 12, a vehicle parameter and engine data module 13, a wireless communication module 14, a computing module 15, a decision module 16, and a vehicle controlling module 17. The information center 2 includes a wireless communication module 21, a map data module 22, a history data module 23, and a route-optimized module 24.

The GPS module 11 is utilized for acquiring information of a current location of the vehicle. Wherein, the GPS module 11 includes a GPS antenna and a GPS receiver for acquiring information of the current location of the vehicle. The information is further sent to the information center 2 for achieving orientation in the map data module 22.

The driving data collecting module 22 is utilized for collecting running data of the vehicle. The running data of the vehicle includes vehicle speed, engine speed, engine torque, position of the accelerator pedal, and position of the breaking pedal. Wherein, the running data of the vehicle can be directly acquired via a CAN bus on the vehicle. Any vehicles that are not provided with the CAN bus, an extra sensor is needed for achieving the data acquiring.

The vehicle parameter and engine data module 13 is utilized for storing a vehicle configuring and engine operating parameter according to different power requirements. Wherein, the vehicle configuring includes ratio of gearbox, ratio of final drive, maximum total mass of the vehicle, wheel rolling radius, transmission efficiency, a coefficient of the revolving mass changes to linear mass, drag coefficient, and frontal area. Moreover, the engine operating parameter is previously and correspondingly set to the current engine parameter of the vehicle. The engine operating parameter might be different when the power requirements are change.

The computing module 15 is utilized for computing a current driving parameter according to the driving data from the driving data collecting module 12. The current driving parameter includes acceleration of the vehicle, a change rate of the accelerator pedal position, and gear of the vehicle. The computing module 15 cooperates with the vehicle configuring from the vehicle parameter and engine data module 13 so as to figure out a current road resistance characteristic coefficient.

The decision module 16 acquires a standard road resistance characteristic coefficient from the route-optimized module 24, current road information from the map data module 22, and the current driving parameter from the computing module 15 so as to judge the power requirement of the vehicle. A correspondent engine operating parameter is acquired from the vehicle parameter and engine data module 13 in accordance with the power requirement of the vehicle.

The vehicle controlling module 17 is connected to the decision module 16 and the engine for receiving the engine operating parameter from the decision module 16 and controlling an output features of the engine.

The map data module 22 is utilized for storing map information related to traveling areas of the vehicle and calling the current road information in accordance with the information of the current location of the vehicle from the GPS module 11. Wherein, the current road information includes a gradient, pavement condition, a road information, and dynamic traffic information. The road property is mainly utilized to recognize roads in the urban area.

The history data module 23 is connected with the onboard computers 1 for storing the current road resistance characteristic coefficient computed by the computing module 15 when each onboard computer 1 passes the area recently. The history data module 23 analyzes and compares the current road resistance characteristic coefficients from different onboard computers 1. Accordingly, the comparison checks the computing results from the onboard computers. If any result is found out of the ordinary, an adjustment is executed. When a parameter in the history data module and a parameter in the route-optimized module 24 that are presenting the same section are compared, changes on the road that are not timely shown on the map can be easily discovered.

The route-optimized module 24 is connected with the history data module 23 for calling the standard road resistance characteristic coefficient corresponding to the current road information. The route-optimized module 24 further sends the standard road resistance characteristic coefficient corresponding to the information of the current location to the decision module 16 of the onboard computers 1.

A method to save fuel in accordance with a practical driving state of the vehicle includes a step of collection and optimization, and a step of execution.

The step of collection and record optimization is utilized to enrich the history data module 23, so that the history data module 23 can store and analyze the history data for acquiring optimized data. The step of collection and record optimization includes:

A1. presetting a vehicle configuring and an engine operating parameter corresponding to different power requirements in each onboard computer 1; presetting map information related to traveling areas of the vehicle in an information center 2; and

A2. allowing each onboard computer 1 to collect current route information and combine with the vehicle configuring coefficient so as to compute the current driving parameter and the current road resistance characteristic coefficient; sending a combination of the current road resistance characteristic coefficient and a current location of the vehicle achieved by the information center 2 so as to store up as history data, which further resulting in a standard road resistance characteristic coefficient corresponding to the current road;

The step of execution mainly ensures that the power of the vehicle is stable by utilizing the history data module 23 and the route-optimized module 24 to acquire the standard road resistance characteristic coefficient. The step of execution includes:

B1. computing the standard road resistance characteristic coefficient corresponding to the current location of the vehicle;

B2. using the current route information, the current driving parameter, and the standard road resistance characteristic coefficient so as to computing power requirement of the vehicle and the engine operating parameter of the vehicle in accordance with the requirement; and

B3. controlling an output features of the engine in accordance with the engine operating parameter.

Accordingly, the present invention utilize the history data module to record and summarize the current road resistance characteristic coefficients computed by all of the onboard computers, so that correspondent standard road resistance characteristic coefficients are acquirable after analyzed. Subsequently, the decision module 16 calculates the power requirement of the vehicle according to the current driving parameter, the standard road resistance characteristic coefficient, and the current road information. The engine operating parameter is correspondingly acquired from the vehicle parameter and engine data module 13 in accordance with the power requirements of the vehicle and executed by the vehicle controlling module 17.

Preferably, the self-adjusting system 100 of the engine includes a human-machine interface module 18 for drivers to input route information. The route information includes a vehicle load and a route features. The decision module 16 judges the power requirement of the vehicle according to the route information, the current road information, the standard road resistance characteristic coefficient, and the current driving parameter. By means of the human-machine interface module 18, a manual operation is available. Whereby, the self-adjusting system 100 of the engine does not execute the self-adjustment; namely, drivers can directly control and adjusting the engine.

The operation of the self-adjusting system 100 of the engine is depicted as follows:

In time of driving, resistance acted on the vehicle mainly include a driving force and a resistance force. A driving resistance equation is:

Fₜ=F_{f}+F_{w}+Fᵢ+Fⱼ

In the equation, Fₜ is the driving force, F_{f} is the rolling resistance, Fᵢ is the grade resistance, and Fⱼ is the accelerating resistance.

The equation is equal to:

$$\frac{{T}_{tq} {i}_{g} {i}_{0} {η}_{τ}}{r} \approx δ ma + mg sin θ + mgf cos θ + \frac{{C}_{D} {Av}^{2}}{21.15}$$

In the equation, T_{tq} is the engine torque, i_{g} is the ratio of gear box, i₀ is the ratio of final drive, r is the wheel rolling radius, η_{τ} is the transmission efficiency, δ is the coefficient of the revolving mass changes to linear mass, m is the mass of the vehicle, a is the acceleration of the vehicle, g is the acceleration of gravity, f is the rolling resistance coefficient, θ is the road gradient, v is the speed of the vehicle, C_{D} is the drag coefficient, and A is the frontal area.

Aforementioned equation can be changed to:

$$λ = ( sin θ + f cos θ ) = \frac{\frac{{T}_{tq} {i}_{g} {i}_{0} {η}_{τ}}{r} - \frac{{C}_{D} {Av}^{2}}{21.15} - δ ma}{mg}$$

λ is the road resistance characteristic coefficient.

Wherein, the engine torque T_{tq} and the speed of the vehicle v can be acquired from the CAN network, or acquired from a correspondent controller. The coefficients i_{g}, i₀, r, η_{τ}, C_{D}, and A are preset in the vehicle parameter and engine data module 13 of the onboard computers 1. When the acquired speed of the vehicle is executed by smooth processing, the acceleration a can be computed by the change rate of the speed of the vehicle.

$$a = \frac{( {v}_{10} + {v}_{9} + {v}_{8} + {v}_{7} + {v}_{6} ) - ( {v}_{5} + {v}_{4} + {v}_{3} + {v}_{2} + {v}_{1} )}{5 T}$$

T is the sampling period of the vehicle speed, v₁ to v₁₀ is the speed value recorded in the last ten period. v₁₀ is the latest speed value.

Moreover, when the change rate of the accelerator pedal is large, the engine torque also changes acutely. Wherein, the mass of the vehicle can not follow up the change of the engine torque, so the computed λ tends to be large, which should be removed. Namely, the computation is merely executed when the accelerator pedal smoothly changes. Therefore, any abnormal engine torque is removed and the rest of the engine torque is executed by smooth processing while the driving data collecting module 12 acquires the current position of the accelerator pedal and the braking position of the accelerator pedal. The gear is also the same. Namely, when the current gear is abnormal or irregular, the resistance characteristic coefficient accordingly computed is not taken into consideration since the improper gear results in abnormal torque coefficient. The mass m of the vehicle includes not only the complete vehicle kerb mass but also the human-machine interface module 18 for allowing drivers to input related data. Accordingly, the current load state of the vehicle can be considered.

In the decision process, the current road resistance characteristic coefficient λ computed by the route-optimized module 24 presents the characteristic of the roads, including the gradient, the road state. The power requirement of the vehicle on current road can be calculated by the following equation:

$${F}_{t} = ( mg λ + \frac{{C}_{D} {Av}^{2}}{21.15} ) \cdot α \cdot β$$

Under toleration, if the limiting speed of the road is smaller than the designed economical speed, the limiting speed of the road is the value v. Oppositely, if the designed economical speed per hour is smaller than the limiting speed of the road, the designed economical speed per hour is the value v. Therefore, the value is subject to the dynamic traffic information. Namely, if the traffic is jammed, the value changes, and the dynamic traffic information defines a qualitative description, such as jammed, or unhindered, according to the state of the traffic. Moreover, the qualitative description is also defined as “The average speed of the vehicle on some road is 20 km/h.” Herein, 20 km/h is the value v since the value presents the speed of the vehicle in the traffic, the state of the traffic can be realized.

α is a reserve-power coefficient; it is a fixed value related to the vehicle type. The reserve-power coefficient guarantees that the vehicle has enough power to accelerate. The value of this reserve-power coefficient considers correlated regulations of the vehicle power performance and the actual experience of the driver, so that the accelerating efficiency of the vehicle is kept within a reasonable range. β is a route coefficient; this coefficient is influenced by a route state of input information from a human-machine interface. For example, the express line or the route of the bus that has a time limitation can provide a superior power when the value β is augmented.

A tractive force Fₜ is computed accordingly. The ratio i₀ is decided by the economical gear under the vehicle speed v. According to the two initial equations:

$${F}_{t} = {F}_{f} + {F}_{w} + {F}_{i} + {F}_{j}$$

$$\frac{{T}_{tq} {i}_{g} {i}_{0} {η}_{τ}}{r} \approx δ ma + mg sin θ + mgf cos θ + \frac{{C}_{D} {Av}^{2}}{21.15}$$

$${F}_{t} = \frac{{T}_{tq} {i}_{g} {i}_{0} {η}_{τ}}{r}$$

is resulted for further calculating the maximum engine torque T_{tq} requirement. The equation P=Fₜ*v computes the maximum power requirement of the engine. Whereby, the final power requirement should satisfy the larger one of the maximum torque requirement and the maximum power requirement.

Consequently, the correspondent engine operating parameter is acquired from the vehicle parameter and engine data module according to afore requirements. Whereby, the vehicle controlling module 17 execute the acquirement. Namely, the vehicle controlling module 17 change the response from the accelerator pedal of the engine so as to reduce influences resulted from the improper driving manners. Moreover, the standard road resistance characteristic coefficient is an optimized value acquired by combining many vehicles. Therefore, the standard road resistance characteristic coefficient is more valuable. Consequently, when the vehicle keeps being powerful, the output features of the engine is controlled more reasonably, and thereby the fuel consumption is efficiently decreased.

While we have shown and described the embodiment in accordance with the present invention, it should be clear to those skilled in the art that further embodiments may be made without departing from the range of the present invention.

I claim:

1. An engine providing a self-adjusting system in accordance with a practical driving state of a vehicle comprising an information center and a plurality of onboard computers connected to said information center;
each onboard computer including:
a GPS module for acquiring information of a current location of said vehicle and sending said information to said information center;
a driving data collecting module for collecting running data of said vehicle; said running data of said vehicle including vehicle speed, engine speed, engine torque, position of the accelerator pedal, and position of the breaking pedal;
a vehicle parameter and engine data module for storing a vehicle configuring and engine operating parameter according to different power requirements;
a computing module for computing a current driving parameter according to said driving data from said driving data collecting module; said current driving parameter including acceleration of said vehicle, a change rate of said accelerator pedal position, and gear of said vehicle; said computing module cooperating with said vehicle configuring coefficient from said vehicle parameter and engine data module so as to figure out the current road resistance characteristic coefficient;
a decision module acquiring a standard road resistance characteristic coefficient from a route-optimized module, current road information from a map data module, and said current driving parameter from said computing module so as to judge the total power requirement of said vehicle; a correspondent engine operating parameter is acquired from said vehicle parameter and engine data module in accordance with said power requirement of said vehicle;
a vehicle controlling module for receiving said engine operating parameter and controlling the output features of said engine;
said information center including:
a map data module for storing map information and calling said current road information in accordance with said information of said current location of said vehicle from said GPS module;
a history data module connected with said onboard computers for storing said current road resistance characteristic coefficient computed by said computing module when each onboard computer passes its current route recently; said history data module analyzing and comparing said current road resistance characteristic coefficients from different onboard computers; and
a route-optimized module connected with said history data module for calling said standard road resistance characteristic coefficient corresponding to said current road information; said route-optimized module further sending said standard road resistance characteristic coefficient corresponding to said current location to said decision module of said onboard computers.

2. The self-adjusting system as claimed in claim 1, wherein, each onboard computer includes a human-machine interface module for drivers to input route information; said route information includes a vehicle load and a road state; said decision module judges said power requirement of said vehicle according to said route information, said current road information, said standard road resistance characteristic coefficient, and said current driving parameter.

3. The self-adjusting system as claimed in claim 1, wherein, said vehicle configuring includes ratio of gearbox, ratio of final drive, maximum total mass of said vehicle, wheel rolling radius, transmission efficiency, a coefficient of the revolving mass changes to linear mass, drag coefficient, and frontal area.

4. The self-adjusting system as claimed in claim 1, wherein, said current route information includes a gradient, pavement condition, a road information, and dynamic traffic information.

5. A method to save fuel in accordance with a practical driving state of a vehicle including a step of collection and optimization and a step of execution; wherein, said step of collection and optimization including:
A1. presetting a vehicle configuring and an engine operating parameter corresponding to different power requirements in each onboard computer; presetting map information related to traveling areas of said vehicle in an information center; and
A2. allowing each onboard computer to collect current route information and combine with said vehicle configuring coefficient so as to compute said current driving parameter and a current road resistance characteristic coefficient; sending a combination of said current road resistance characteristic coefficient and a current location of said vehicle achieved by said information center so as to store up as history data, which further resulting in a standard road resistance characteristic coefficient corresponding to said current road;
said step of execution including:
B1. computing said standard road resistance characteristic coefficient corresponding to said current location of said vehicle;
B2. using said current route information, said current driving parameter, and said standard road resistance characteristic coefficient so as to computing power requirement of said vehicle and said engine operating parameter of said vehicle in accordance with the requirement; and
B3. controlling an output features of said engine in accordance with said engine operating parameter.

6. The method as claimed in claim 5, wherein, in step A1, a human-machine interface module is arranged for drivers to input route information; said route information includes a vehicle load and a route features; in step A2, using said vehicle load when said driving parameter is computed; in step B2, combining said route information, said current road information, said standard road resistance characteristic coefficient, and said current driving parameter to judge said power requirement of said vehicle.

7. The method as claimed in claim 5, wherein, said vehicle configuring coefficient includes said vehicle configuring includes ratio of gearbox, ratio of final drive, maximum total mass of said vehicle, wheel rolling radius, transmission efficiency, a coefficient of the revolving mass changes to linear mass, drag coefficient, and frontal area.

8. The method as claimed in claim 5, wherein, said route information includes a vehicle speed, engine speed, engine torque, a position of the accelerator pedal, and position of the breaking pedal; said current driving parameter includes a resistance, an acceleration of said vehicle, a change rate of said accelerator pedal position, and a gear.

9. The method claimed in claim 5, wherein, said current route information includes a gradient, pavement condition, a road information, and dynamic traffic information.
